(19) United States
(12) Patent Application Publication
(10) Pub. No.: US 2003/0038436 A1
(43) Pub. Date: Feb. 27, 2003

(54) Snow sled with deformable steering mechanism

(76) Inventor: Andrew F. Fireman, North Bethesda, MD (US)

Correspondence Address: Steven N. Fox, Esq., P.O. Box 251, Canton, MA, 02021, US

(21) Appl. No.: 09/935,730

(22) Filed: Aug. 22, 2001

(51) Int. Cl. B62B 9/04

(52) U.S. Cl. 280/21.1; 280/845

(57) ABSTRACT

The present invention is a snow sled that allows a person to sit and steer the sled by applying a force with their left or right foot. The snow sled comprises a body member connected to a front steering member by a flexible neck member. The body member and the front steering member each comprise a top portion and a bottom portion adapted to slide on the snow. The body member further comprises a seat portion adapted for seating by the person. The steering member further comprises left and right foot mounting portions adapted to receive the left and right feet of the person. A person may make move the sled to the left by extending their right foot to apply a force to the right foot mounting portion. The person may move the sled to the right by extending their left foot to apply a force to the left foot mounting portion.

### FIELD OF THE INVENTION

The present invention relates to snow sleds used for recreational. More specifically, the present invention relates to snow sleds that can be steered by a person.

### BACKGROUND OF THE INVENTION

A wide variety of snow sleds have been designed that allow a person to steer the sled as it slides down a hill of snow. Such designs have focused on a steering mechanism located at the front of the sled that require the person to lie flat on their stomach. Such conventional designs are not well suited for both children and adults: many adults do feel uncomfortable lying on their stomach.

### SUMMARY OF THE INVENTION

The present invention is a snow sled that allows a person to sit and steer the sled by applying a force with their left or right foot. The snow sled comprises a body member connected to a front steering member by a flexible neck member. The body member and the front steering member each comprise a top portion and a bottom portion adapted to slide on the snow. The body member further comprises a seat portion adapted for seating by the person. The steering member further comprises left and right foot mounting portions adapted to receive the left and right feet of the person. A person may make move the sled to the left by extending their right foot to apply a force to the right foot mounting portion. The person may move the sled to the right by extending their left foot to apply a force to the left foot mounting portion.

### BRIEF DESCRIPTION OF THE DRAWINGS

The following detailed description of the invention will be more fully understood with reference to the accompanying drawings in which:

FIG. 1 is a top plan view of a snow sled of the present invention;

FIG. 2 is a cross-section view taken along line 2-2 of FIG. 1;

FIG. 3 is a cross-section view taken along line 3-3 of FIG. 1; and

FIG. 4 is a top plan view of a second embodiment of the snow sled; and

FIG. 5 is a cross-section view taken along line 5-5 of FIG. 4.

### DETAILED DESCRIPTION OF THE INVENTION

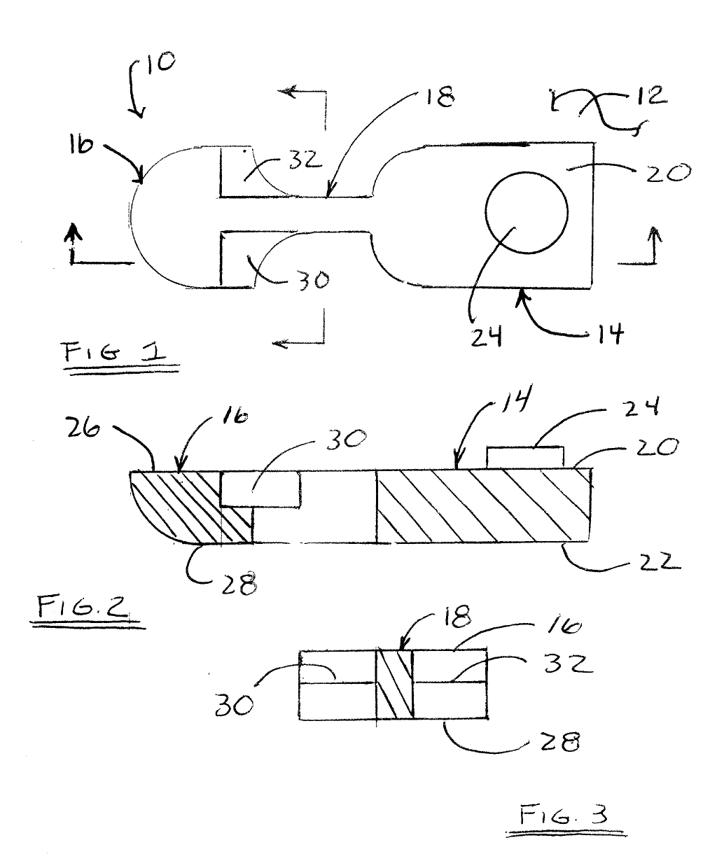

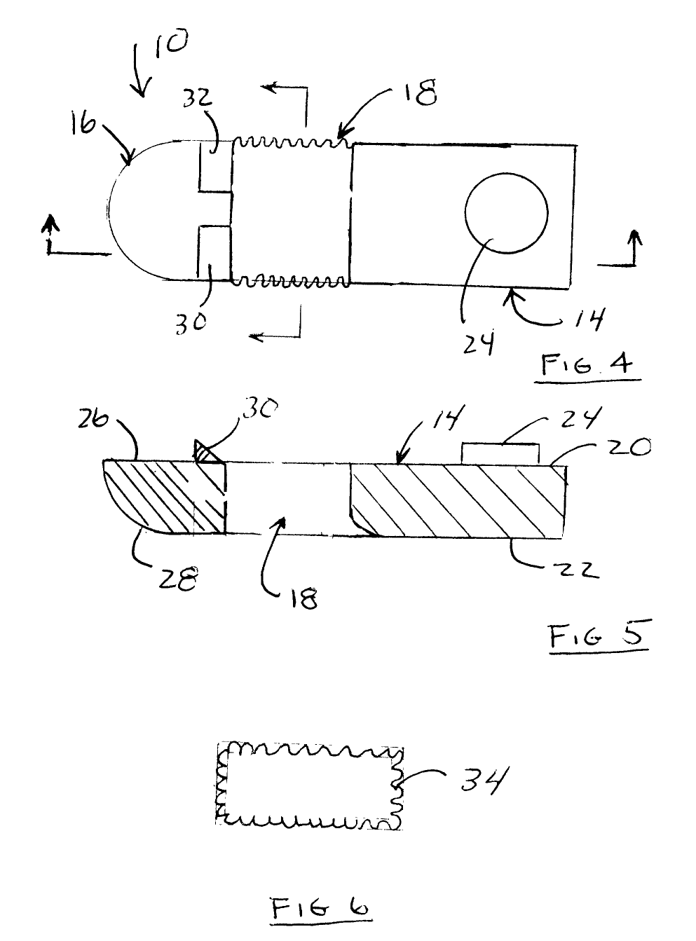

Referring to FIGS. 1-3, where a first embodiment of the snow sled 10 is shown on a snow surface 12. The snow sled 10 comprises a body member 14 connected to a front steering member 16 by a flexible neck member 18. The body member 14 comprises a top portion 20 and a bottom portion 22 adapted to slide on the snow. The body member 14 further comprises a seat portion 24 adapted for seating by the person. The front steering member 16 comprises a top portion 26 and a bottom portion 28 adapted to slide on the snow. The front steering member 16 further comprises left and right foot mounting portions 30 and 32 adapted to receive the left and right foot of the person, respectively. The neck member 18 has a width that substantially narrower than the width of the body member 14 and the steering member 18. The neck member 18 is preferably made from a resilient and stretchable material. The decreased width of the neck member 18 and its flexible and resilient properties allows the neck member to stretch. With the snow sled 10 of the present invention, a person may sit and steer the sled by applying a force with their left or right foot. A person may make move the sled to the left by extending their right foot to apply a force to the right foot mounting portion 32. The person may move the sled to the right by extending their left foot to apply a force to the left foot mounting portion 30. The sled 10 is preferably made from plastic materials and may be formed using injection molding processes.

Referring to FIGS. 4 and 6, a second embodiment of the snow sled 10 is shown. In the second embodiment, the neck member 18 comprises a baffle or accordion wall 34 that has substantially the same width as the body member 14 and steering member 18. Unlike the first embodiment, the neck member 18 may be made from a substantially rigid material and the accordion wall 34 allows the neck member 18 to expand and compress.

The foregoing description is intended primarily for purposes of illustration. This invention may be embodied in other forms or carried out in other ways without departing from the spirit or scope of the invention. Modifications and variations still falling within the spirit or the scope of the invention will be readily apparent to those of skill in the art.

What is claimed is:

1. A snow sled for use by a person on snow, the snow sled comprises a body member connected to a front steering member by a flexible neck member, said body member and said front steering member each comprise a top portion and a bottom portion adapted to slide on the snow, said body member further comprises a seat portion adapted for seating by the person, said steering member further comprises left and right foot mounting portions, whereby the person may sit on said seat portion and engage their feet with said left and right mounting portions to thereby steer the sled by exerting a force on said left foot or right foot mounting portion.

2. The snow sled of claim 1, wherein said neck member is substantially more deformable than said body member.

3. The snow sled of claim 2, wherein said neck member is stretched upon application of said force to said right foot mounting portion to make a left turn.

4. The snow sled of claim 4, wherein said neck member is stretched upon application of the low force to said left foot mounting portion to make a right turn.

5. The snow sled of claim 1, wherein said neck member is substantially narrower than said front steering member and said body member.

6. The snow sled of claim 2, wherein said first and second foot mounting portions are disposed on opposite sides of said neck member.

7. The snow sled of claim 6, wherein each of said body member, said neck member, and front steering member are made from a plastic material.

8. The snow sled of claim 7, wherein said body member and said neck member and said front steering member are made from a molding process to form a one-piece molded sled.
